(19) United States
(12) Patent Application Publication
(10) Pub. No.: US 2024/0208130 A1
(43) Pub. Date: Jun. 27, 2024

(54) EXTRUDER-MIXER

(71) Applicant: BB Engineering GmbH, Remscheid (DE)

(72) Inventors: Friedel Dickmeiss, Langenfeld (DE); Wolfgang Imping, Remscheid (DE); Nils Stary, Wuppertal (DE); Ludger Reichling, Wermelskirchen (DE)

(21) Appl. No.: 18/556,032

(22) PCT Filed: Apr. 14, 2022
(86) PCT No.: PCT/EP2022/060044

§ 371 Date: Oct. 18, 2023

(30) Foreign Application Priority Data
Apr. 20, 2021 (DE) 10 2021 002 064.2

(51) Int. Cl. B29C 48/36; B29B 7/40; B29B 7/42; B29C 48/67

(52) U.S. Cl. CPC B29C 48/361; B29B 7/408; B29B 7/425; B29C 48/67

(57) ABSTRACT

An extruder-mixer has a stator and a rotor arranged coaxially to the stator. The rotor is mounted rotatably relative to the stator. The stator, at least in portions, is arranged inside a volume spanned by the rotor. Such an extruder-mixer may be with an extruder. An extruder screw may be mounted in a screw housing of the extruder and coupled to a screw drive of the extruder.

The present invention concerns an extruder-mixer with a stator and a rotor arranged coaxially to the stator, wherein the rotor is mounted rotatably relative to the stator.

Extruder-mixers of the type cited initially are known in principle from the prior art and are typically used for mixing viscous and partially filled fluids, and melted polymers. A device for mixing plasticizable synthetic resins is disclosed in utility model specification DE 7433808 U.

European patent specification EP 0 048 590 B1 describes an extruder-mixer with a hollow cylindrical stator and a cylindrical rotor mounted inside the stator for rotation. The mutually facing cylindrical surfaces of the rotor and stator each comprise pluralities of parallel cavity rows extending over a circumference.

An extruder-mixer with an extruder screw, consisting of at least one sleeve and a cylindrical screw tip mounted therein, is disclosed in German patent application DE 10 2007 022 287 A1.

The object of the present invention is to provide an alternative extruder-mixer.

An extruder-mixer is a device specifically configured for use in an extruder and serving for mixing material to be extruded. Not every device suitable for mixing a fluid can therefore be classed as an extruder-mixer.

The extruder-mixer has a rotor and a stator. The rotor can rotate relative to the stator. The stator is not rotatable in that, on normal use of the extruder-mixer, the stator cannot be rotated. It may for example be the case that the stator is fixedly mounted. Preferably, no further element is arranged between the rotor and the stator.

The object is achieved in that the stator, at least in portions, is arranged inside a volume spanned by the rotor. It has proved advantageous if the majority of the stator, relative to its stator length in the axial direction, is arranged inside the rotor. The extruder-mixer according to the invention creates the basis for extruders with a high mixing performance and small installation space. It has furthermore been found that an extruder-mixer, in which the stator is arranged at least in portions inside a volume spanned by the rotor, can be retrofitted to existing extruders comparatively easily. Also, variability is possible by simple axial positioning of the stator. A decisive additional advantage of the extruder-mixer according to the invention is the possibility of being able to supply an additive or multiple additives through the stator into an inner volume of the rotor.

The invention includes the finding that in all extruder-mixers of the prior art, the rotor is arranged rotatably inside the stator. By deviation from this technical prejudice, in the extruder-mixer according to the invention, the stator is arranged at least partially inside a volume spanned by the rotor. It has proved advantageous if a majority of the length of the stator is arranged inside the volume spanned by the rotor.

In a particularly preferred embodiment, the stator has an in particular elongate recess and the rotor has at least one in particular elongate opening. In a further particularly preferred embodiment, the recess and the opening are arranged such that the recess and the opening overlap for at least part of the time during operation of the extruder-mixer. Preferably, the stator has a multiplicity of recesses and/or the rotor has a multiplicity of openings. Preferably, the recesses cover at least 30%, in particular at least 50% or even at least 80% of a casing surface of the stator. Preferably, the openings cover at least 30%, in particular at least 50% or even at least 80% of a casing surface of the rotor. The fluid can be mixed particularly well by means of the recesses and openings.

In a further particularly preferred embodiment, the rotor has a rotor cage. It has proved advantageous if the stator has an axial bore via which a fluid can be introduced into the rotor. It has proved advantageous if, relative to the stator length in the axial direction, the majority of the stator is arranged inside the rotor cage. A rotor cage is a lattice structure which is formed by lattice webs and openings formed in-between.

In a particularly preferred embodiment, the rotor has a multiplicity of openings. The opening or openings may each be provided as a bore or slot. In a particularly preferred embodiment, the openings of the rotor are arranged in multiple opening rows. It has proved advantageous if the opening rows each extend in the longitudinal direction (axial direction) of the rotor, in particular parallel to a rotational axis of the rotor. In a further particularly preferred embodiment, the opening rows are arranged on the rotor with even mutual spacing along a circumference of the rotor. It has proved advantageous if the openings are formed elongate in the longitudinal direction and their longitudinal direction in each case runs parallel to a rotational axis of the rotor. Alternatively, the longitudinal direction of the openings may in each case run obliquely to a rotational axis of the rotor.

In a further particularly preferred embodiment, the recesses on the stator are formed elongate in a longitudinal direction and the longitudinal direction in each case runs parallel to a rotational axis of the rotor. Alternatively, the longitudinal direction of the recesses may in each case run obliquely to the rotational axis of the rotor. The longitudinal direction of an opening may be parallel to a longitudinal direction of a recess. The longitudinal direction of an opening may be oblique or tilted relative to a longitudinal direction of a recess.

In a further particularly preferred embodiment, the stator has a multiplicity of recesses. In a particularly preferred embodiment, the stator recesses are arranged in multiples recess rows. It has proved advantageous if the recess rows each extend in the longitudinal direction of the stator, in particular parallel to the rotational axis of the rotor. In a further particularly preferred embodiment, the recess rows are arranged on the stator with even mutual spacing along a circumference of the rotor. It has proved advantageous if the longitudinal portion of the stator, on which the multiplicity of recesses involved in the mixing process are formed, is arranged for the most part—preferably at least 50 percent, further preferably at least 80 percent—inside the rotor and/or rotor cage.

It has proved advantageous if an opening of the rotor is in each case positioned centrally offset to a corresponding recess of the stator. A central offset may relate to the circumferential direction and/or the longitudinal direction of the stator. The number and size of recesses in the stator and the number and size of openings in the rotor, and the axial positioning of rotor and stator relative to one another, achieve a variation in the mixing effect (due to the changing overlap of inlets/outlets). Thus for example, by replacing the stator, the mixing performance of the extruder-mixer can be significantly influenced. The arrangement of the openings of the rotor and the corresponding recesses in the stator is preferably selected in rows and/or with a central offset of preferably 50 percent of a row unit. An axial shift of the stator relative to the rotor may vary the offset (overlap) (10-50%/90-50%).

In a further particularly preferred embodiment, the openings of the rotor are arranged in an axially offset or helical arrangement. It has proved advantageous if the openings of the rotor are provided in a single-turn or multiturn helix, and the openings preferably correspond to the recesses of the stator. It has proved advantageous if the recesses of the stator are made in a single-turn or multiturn helix.

In a further particularly preferred embodiment, the openings in the rotor and/or the corresponding recesses in the stator are shaped as domes, part circle discs or grooved channels.

In a particularly preferred embodiment, the number of recesses in the stator differs from the number of openings in the rotor. It has proved advantageous if the number of openings in the rotor is at least one more than the number of corresponding recesses in stator.

It has proved particularly advantageous if a width of the openings in the rotor and/or a width of the corresponding recesses in the stator is preferably 5 to 35 mm. A width of the openings and recesses is determined in the circumferential direction of the rotor or stator. A length of the openings in the rotor and/or a length of the corresponding recesses in the stator is preferably a multiple, preferably by a factor of 2 to 5, of the respective width of the opening and/or recess. In a further particularly preferred embodiment, a maximum depth of the recess in the stator relative to a radial direction of the stator is preferably 5 to 15 mm. With a view to rheological optimization, it has proved advantageous if the radii of the openings and/or the radii of the recesses are proportional to the respective widths. In a particularly preferred embodiment, a radius amounts to more than 2 mm.

It has proved advantageous if the openings of the rotor and/or the recesses of the stator, relative to the respective longitudinal direction, extend parallel to the rotational axis of the rotor. Alternatively, the openings of the rotor and/or the recesses of the stator, relative to the respective longitudinal direction, may extend at an angle to the rotational axis of the rotor. It has proved advantageous if such an angle lies within a range from −45° to +45° relative to the rotational axis.

The invention is also achieved by an extruder with an extruder-mixer of the above-described type and with an extruder screw which is mounted in a screw housing of the extruder and coupled to a screw drive of the extruder. The extruder according to the invention may be refined accordingly by the features described with respect to the extruder-mixer. It has proved advantageous if the rotor, at least in portions, is arranged inside a volume spanned by the screw housing. It has proved advantageous if the rotor, relative to its rotor length in the axial direction, is arranged for a most part inside the screw housing. In a particularly preferred embodiment, the stator, rotor and screw housing are arranged coaxially to one another.

In a particularly preferred embodiment, the screw drive is rotationally coupled to the rotor of the extruder-mixer. In other words, a rotation of the screw drive preferably results in a rotation of the rotor of the extruder-mixer.

In a further particularly preferred embodiment, the extruder has an extruder head. It has proved advantageous if the screw housing is flanged to the extruder head. In a particularly preferred embodiment, the stator of the extruder-mixer is arranged rotationally fixedly relative to the extruder head. The stator may be bolted to the extruder head. It has proved advantageous if the extruder screw is formed integrally with the rotor. In a further particularly preferred embodiment, the screw drive is arranged on a side of the screw housing facing away from the extruder head. In a further particularly preferred embodiment, the extruder has a rotor drive which can be operated independently of the screw drive. It has proved particularly advantageous if the rotor drive is rotationally coupled to the rotor of the extruder-mixer. It has proved advantageous if the screw drive is arranged on the side having the screw housing. Alternatively, the screw drive may be arranged on the side having the rotor of the extruder-mixer.

Further advantages arise from the following description of the figures. The figures illustrate various exemplary embodiments of the present invention. The figures, the description and the claims contain numerous features in combination. The person skilled in the art will also consider the features individually where appropriate, and combine these into suitable further combinations. In the figures, the same and similar components carry the same reference signs. In the drawings:

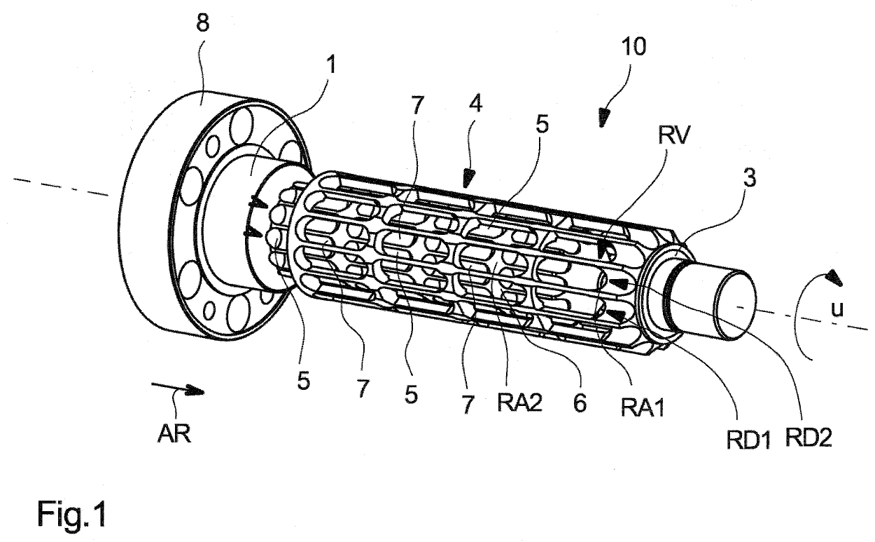

FIG. 1 shows a first preferred exemplary embodiment of an extruder-mixer according to the invention;

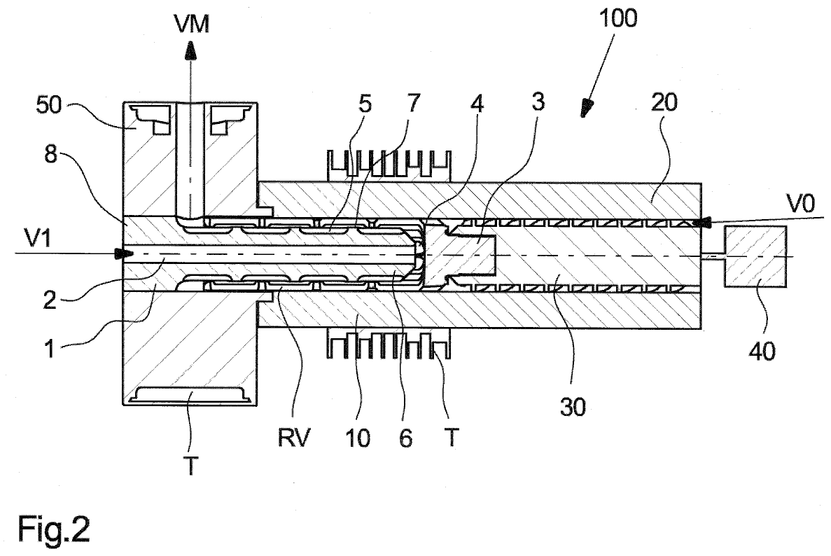

FIG. 2 shows a first preferred exemplary embodiment of an extruder according to the invention;

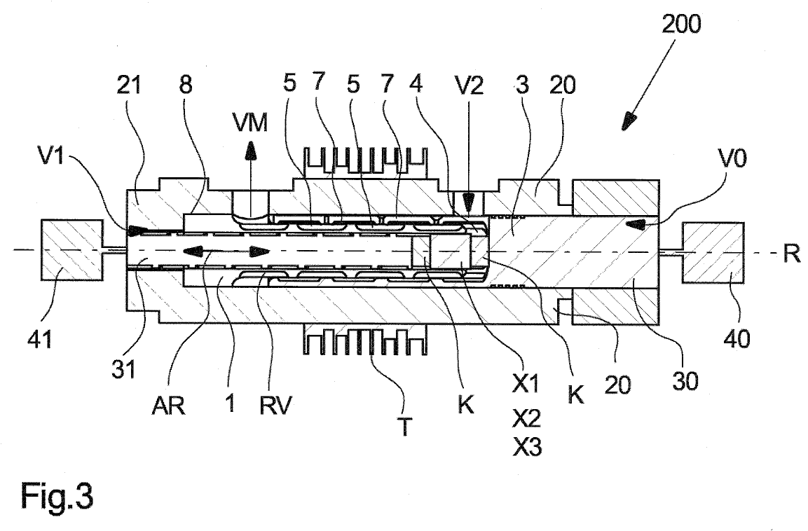

FIG. 3 shows a second preferred exemplary embodiment of an extruder according to the invention;

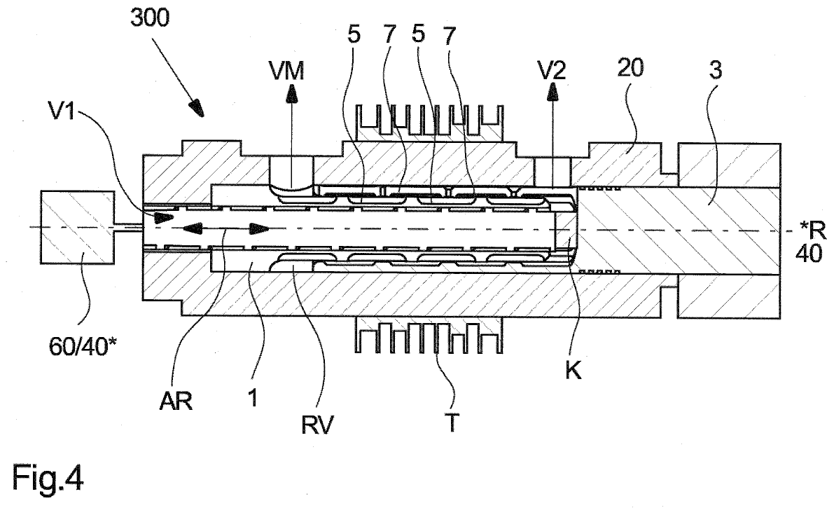

FIG. 4 shows a third preferred exemplary embodiment of an extruder according to the invention;

FIG. 5 shows a fourth preferred exemplary embodiment of an extruder according to the invention;

FIG. 6 shows a preferred exemplary embodiment of a rotor cage;

FIG. 7 shows a preferred exemplary embodiment of a stator; and

FIG. 8 shows an assembly of the rotor cage from FIG. 6 with the stator from FIG. 7.

A first preferred exemplary embodiment of an extruder-mixer 10 according to the invention is shown in FIG. 1. The extruder-mixer 10 is equipped with a stator 1 and a rotor 3 arranged coaxially to the stator 1. The rotor 3 is mounted rotatably relative to the stator 3. During operation, the rotor 3 rotates about the rotational axis R. The stator 1 has a multiplicity of recesses 5, and the rotor 3 has a multiplicity of openings 7. At least one recess 5 overlaps with at least one opening 7.

According to the invention, the stator 1 is arranged at least in portions inside a volume RV spanned by the rotor 3. As FIG. 1 shows, a stator shaft 6 of the stator 3 is arranged for a most part, relative to the axial direction AR, inside a rotor cage 4 of the rotor 3. A stator shaft 6 in particular means the region of the stator 3 on which the multiplicity of recesses 5 are formed. The stator 3 comprises the stator shaft 6 and a stator head 8 formed integrally with the stator 6. A rotor cage 4 in particular means the region of the rotor 3 on which the multiplicity of openings 7 are formed.

As FIG. 1 also shows, the openings 7 of the rotor 3 are arranged in multiple opening rows RD1, RD2 etc. The opening rows RD1, RD2 each extend in the axial direction AR and are arranged on the rotor 3 with even mutual spacing along a circumference U of the rotor 3. The recesses 5 of the stator 1 are arranged in multiple recess rows RA1, RA2 etc. The recess rows RA1, RA2 each extend in the axial direction AR and are arranged on the stator 1 with even mutual spacing along a circumference U of the stator 1.

The stator 1 also has an axial bore 2 (see FIG. 2) via which a fluid can be introduced into the rotor 3.

A first preferred exemplary embodiment of an extruder 100 according to the invention is shown in FIG. 2. The extruder 100 has an extruder-mixer 10 according to the exemplary embodiment from FIG. 1. As FIG. 2 shows, the extruder 100 is equipped with an extruder screw 30 mounted in a screw housing 20 of the extruder 100. The extruder screw 30 is coupled to a screw drive 40 of the extruder 100, so that the extruder screw 30 can be set in rotation about the rotational axis R. The screw drive 40 is arranged on a side of the screw housing 20 facing away from the extruder head 50.

The extruder 100 has an extruder head 50, wherein the screw housing 30 is flanged to the extruder head 50. The stator head 8 of the stator 1 of the extruder-mixer 10 is bolted to the extruder head 50 and is thus rotationally fixed relative to the extruder head 50. The term “extruder head” as a concept means that this component with the described functions is positioned on the head end of an extruder and preferably receives measuring devices for physically describing the extruded fluid or polymer (e.g. pressure and temperature sensors).

The screw drive 40 is itself rotationally coupled to the rotor 3 of the extruder-mixer 10 so that the rotor 3 can be set in rotation about the rotational axis R. In the present exemplary embodiment, the extruder screw 30 is rotationally coupled to the rotor 3 of the extruder-mixer 10, so that the screw drive 40 drives in rotation both the extruder screw 30 and also the rotor 3.

FIG. 2 clearly shows the axial bore 2 which extends coaxially to the rotational axis R inside the stator 1. Via the axial bore 2, a fluid, e.g. a paint component, may be introduced into the rotor 3.

The extruder head 50 centrically receives a one-piece or multipiece stator 1. This stator 1 integrates the functions of a stationary stator head 8, the axial bore 2 (or in some cases also a multiplicity of bores) for connection and supply of the components to be mixed to the mixing chamber which is formed by the rotor 3. In the bore(s) of the stator shaft 6 configured as an outlet region, mechanical or hydraulically controlled fittings may be provided for temporary blockage and/or choking of the supplied fluids. The fluid flow emerging from the axial bore 2 is pressed into the central mixer cavity positioned centrically on the head side, and from there evenly distributed radially over the circumference and the first openings 4. In the region of the extruder head 8, the stator 1 also contains the described recesses 5 (stator cavities) which are arranged correspondingly to the openings 7 (rotor openings) of the rotor 3. Both the extruder head 50 and the filling piece 1 are provided with bores for receiving sensors. Heating may take place both by liquid media and by contact and convection heating. Proper operation allows the clockwise and counterclockwise rotation of the rotor 3 and the connected extruder screw 30 about the central stator 1. The stator 1 may again be assembled from multiple components, which preferably allows simple variation/exchange of the recesses 5 (mixer cavities).

A second preferred exemplary embodiment of an extruder 200 according to the invention is shown in FIG. 3. The extruder 200 has an extruder-mixer 10 according to the exemplary embodiment of FIG. 1. The extruder 200 is equipped with an extruder screw 30 mounted in a screw housing 20 of the extruder 200. The extruder screw 30 is coupled to a screw drive 40 of the extruder 200, so that the extruder screw 30 can be set in rotation about the rotational axis R. In contrast to the exemplary embodiment of FIG. 2, in the extruder 200 of FIG. 3, the separate or extended screw housing 21 with extruder screw 31 and additional screw drive 41—which may be jointly designated the feed unit—may be arranged on a side facing away from the rotor 3 inside the stator head 8.

As FIG. 3 shows, the extruder 200 has a second drive 41 which can be operated independently of the screw drive 40 (or rotor drive 60). The drive 41 is rotationally coupled to an extruder screw 31 which rotates in a temperable cylinder—which may be separately flanged to or formed integrally with the cylinder of the extruder-mixer 100—and conveys a fluid or produces polymer melt. This second drive 41 is arranged opposite the screw drive 40 (or rotor drive 60) relative to the stator head 8, and uses both the cylinder 21 and the stator 8 as an enveloping cylinder. In the outlet region of the stator head 6, either a mechanically or a hydraulically working function unit X is positioned on the rotating extruder screw 31, or by a corresponding design of the outlet region and the axial positionability of the rotating extruder screw 31, a choke effect and/or blockage of the outlet is possible. The tempering of the cylinders 20 and 21 may be achieved both by liquid media and by contact and convection heating (and combinations). Proper use allows the clockwise and counterclockwise rotation of the connected screw 21 in the central filler piece 8, which also contains the described cavities (stator cavities) 5 which are arranged correspondingly to the openings of the rotor 7 (rotor openings).

The mechanically or hydraulically working function unit X positioned in the outlet region of the stator shaft 6 may alternatively be coupled to the screw drive 40 (or rotor drive 60). The particular embodiments of the function unit X are as a choke unit X1, a blocking unit X2 or volume pump X3.

A third preferred exemplary embodiment of an extruder 300 according to the invention is shown in FIG. 4. The extruder 300 has an extruder-mixer 10 according to the exemplary embodiment of FIG. 1. As in the exemplary embodiment of FIG. 3, in the extruder 300 of FIG. 4, the screw housing 20, the extruder screw 30 and the screw drive 40—which may be jointly designated the feed unit—are arranged on the side of the stator head 8 facing away from the rotor 3.

In contrast to the exemplary embodiment of FIG. 3, the extruder 100 of FIG. 4 has only one drive in the form of a screw drive 40. The screw drive 40 is arranged on the side having the screw housing 20. Alternatively, instead of the screw drive 40, a rotor drive 60 may be arranged on the side having the rotor 3 of the extruder-mixer 10.

A rotational coupling of the screw drive 40 with the rotor 3 of the extruder-mixer 10 is achieved by a coupling rod which extends through the stator 1 coaxially to the rotational axis R.

Proper operation is achieved by the supply of volume flows of different polymers and/or fluids via the screw conveyor and/or feed bores into the extruder-mixer. FIG. 2 shows the minimal case of polymer preparation via a screw V0 and the pressure feed of a second volume flow V1 into the extruder-mixer 10. An outlet bore discharges the mixture as a volume flow VM from the extruder-mixer 10. The number of pressure feeds of further volume flows VX is not limited.

The illustration in FIG. 3 shows the proper operation by the supply of two volume flows V0, V1 via the separately driven screws/rotors, and the pressure feed of a third volume flow V2 into the extruder mixer 10. An outlet bore discharges the mixture as volume flow VM from the extruder-mixer 10. The number of pressure feeds of further volume flows VX is not limited.

The illustration in FIG. 4 shows the proper operation by the supply of volume flow V1 via the coupled-driven screws/rotors and the pressure feed of a second volume flow V2 into the extruder-mixer 10. An outlet bore discharges the mixture as volume flow VM from the extruder-mixer 10. The number of pressure feeds of further volume flows VX is not limited.

A fourth exemplary embodiment of an extruder 200 according to the invention is shown in FIG. 5. The exemplary embodiment of FIG. 4 structurally resembles the exemplary embodiment of FIG. 2, with the difference that in proper operation of the extruder 200 of FIG. 4, there is not and cannot be any supply of volume flow V0 on the screw drive side. In proper operation, the volume flows V1, V2, and VX are supplied into the extruder head 50, i.e. perpendicularly to the rotational axis R of the rotor 3. The volume flow VM (volume flow “mixture”) in proper operation emerges from the stator 1 through the axial bore 2.

FIG. 6 shows a preferred exemplary embodiment of the rotor 3 having a rotor cage 4 with a plurality of openings 7. In contrast to the exemplary embodiments of FIGS. 1 to 5, in which the openings 7 are formed elongate in the longitudinal direction and their longitudinal direction in each case runs parallel to a rotational axis R of the rotor 3, the longitudinal direction L7 of the openings 7 does not run parallel to the rotational axis R of the rotor 3.

FIG. 7 shows a preferred exemplary embodiment of a stator 1 which has a multiplicity of recesses 5. In contrast to the exemplary embodiments of FIGS. 1 to 5, in which the recesses are formed elongate in the longitudinal direction and the longitudinal direction in each case runs parallel to a rotational axis R of the rotor 3, the longitudinal direction L5 of the recesses 5 does not run parallel to the rotational axis R of the rotor 3 (not shown here).

Finally, FIG. 8 shows an extruder-mixer as an assembly of the rotor 3 from FIG. 6 with the stator 1 from FIG. 7. As FIG. 8 shows, the longitudinal direction L7 of the openings 7 does not run parallel to the longitudinal direction L5 of the recesses 5. The mixing behavior of the extruder-mixer can be positively influenced thereby.

### LIST OF REFERENCE SIGNS

1 Stator
2 Axial bore
3 Rotor
4 Rotor cage
5 Recess
6 Stator shaft
7 Opening
8 Stator head
10 Extruder-mixer
20 Screw housing
21 Screw housing
30 Extruder screw
31 Extruder screw
40 Screw drive
41 Screw drive
50 Extruder head
60 Rotor drive
100 Extruder with extruder-mixer
200 Extruder/extruder-mixer independent
300 Extruder/extruder-mixer coupled
AR Axial direction
R Rotational axis
RA Recess row
RD Opening row
RV Rotor volume
T Tempering
U Circumference
K Coupling
X Function unit (couplable)
X1 Choke function unit
X2 Blocking function unit
X3 Pump function unit
V0 Volume flow “0”
V1 Volume flow “1”
V2 Volume flow “2”
VX Volume flow “X”
VM Volume flow “mixture”

1. An extruder-mixer having a stator and a rotor arranged coaxially to the stator, wherein the rotor is mounted rotatably relative to the stator, and wherein the stator, at least in portions, is arranged inside a volume spanned by the rotor.

2. The extruder-mixer as claimed in claim 1, wherein the stator has at least one recess and the rotor has at least one opening, and wherein the recess and the opening overlap for at least part of the time during operation of the extruder-mixer.

3. The extruder-mixer as claimed in claim 1,
wherein the rotor has a rotor cage with a plurality of openings.

4. The extruder-mixer as claimed in claim 3, wherein the openings are formed elongate in a longitudinal direction and their longitudinal direction in each case runs parallel to a rotational axis of the rotor.

5. The extruder-mixer as claimed in claim 3, wherein the openings are formed elongate in a longitudinal direction and their longitudinal direction in each case runs obliquely to a rotational axis of the rotor.

6. The extruder-mixer as claimed in claim 1,
wherein the stator has an axial bore via which a fluid may be introduced into the rotor.

7. An extruder with an extruder-mixer as claimed in claim 1 and with an extruder screw which is mounted in a screw housing of the extruder and coupled to a screw drive of the extruder.

8. The extruder as claimed in claim 7, wherein the extruder has an extruder head, and wherein the screw housing is flanged to the extruder head, and the stator of the extruder-mixer is rotationally fixed relative to the extruder head.

9. The extruder as claimed in claim 8, wherein the extruder screw is formed integrally with the rotor.

10. The extruder as claimed in claim 9, wherein the screw drive is arranged on a side of the screw housing facing away from the extruder head.

11. The extruder as claimed in claim 7, wherein the screw drive is arranged on the side having the screw housing.

12. The extruder as claimed in claim 7, wherein the screw drive is arranged on the side having the rotor of the extruder-mixer.

13. The extruder as claimed in claim 7, wherein the extruder has a rotor drive which can be operated independently of the screw drive, and wherein the rotor drive is rotationally coupled to the rotor of the extruder-mixer.

14. The extruder as claimed in claim 11, wherein the screw drive of an extruder or a separate rotor drive is rotationally coupled to the rotor of the extruder-mixer, and a further screw drive with extruder screw works centrically to the rotational axis within the stator head.

15. The extruder as claimed in claim 11, wherein the screw drive with extruder screw works centrically to the rotational axis and is positionable in the axial direction.

16. The extruder as claimed in claim 11, wherein either the screw drive of an extruder or a separate rotor drive is coupled to a function unit in the interior of the stator.

17. The extruder as claimed in claim 16, wherein the function unit in the interior of the stator has the function of a choke.

18. The extruder as claimed in claim 16, wherein the function unit in the interior of the stator has the function of a blocking device.

19. The extruder as claimed in claim 16, wherein the function unit in the interior of the stator has the function of a volume pump.

20. The extruder as claimed in claim 7, wherein the extruder has only one screw drive or rotor drive, and wherein the rotor and the extruder screw are rotationally coupled.

21. The extruder as claimed in claim 20, wherein the extruder has the screw drive or rotor drive positioned at one of the two ends of the rotationally coupled unit.
